(19) United States
(12) Patent Application Publication
(10) Pub. No.: US 2012/0036531 A1
(43) Pub. Date: Feb. 9, 2012

(54) METHOD AND APPARATUS FOR GENERATING AUTOMATIC MEDIA PROGRAMMING THROUGH VIEWER PASSIVE PROFILE

(76) Inventor: GREGORY J. MORROW, Los Angeles, CA (US)

(21) Appl. No.: 13/204,496

(22) Filed: Aug. 5, 2011

Related U.S. Application Data
(60) Provisional application No. 61/371,141, filed on Aug. 5, 2010.

(51) Int. Cl. H04N 21/266

(52) U.S. Cl. 725/34

(57) ABSTRACT

The system described herein works by eliminating the need for a viewer to actively select media. Instead, this new method creates a viewer passive profile by analyzing viewer and media metadata and then provides such media directly to the viewer through the system whenever the system is activated or whenever the user wants to watch it (time preference). Active selection of media by the viewer is no longer necessary. Instead, the viewer automatically receives his or her media profile preferences in a timely fashion.

This patent application claims priority to U.S. Provisional Patent Application 61/371,141 filed on Aug. 5, 2010 and incorporated by reference herein in its entirety.

### BACKGROUND OF THE SYSTEM

Since inception, viewers of media have faced the inherent need to actively select media programming for viewing. As media content has proliferated and become more varied as well as unstructured, this active selection process by the viewer has become tedious and stupefying. The system resolves the need to actively select media (e.g., through hand-held remote control unit, keyboard, direct media display access, etc.) by creating a passive profile by use of metadata (embedded and electronically stored descriptive, structural, administrative and other data about the viewer, such as age or sex, geographic location, or profession or other demographic information, as well as about the media, such as drama or sports or variety or other information, that the viewer tends to prefer based on monitoring the viewer's watching preferences over time and at specific times) and then streaming such media directly to the viewer through the system programming (there is no need to actively select via remote control or direct access). The viewer automatically receives his or her media profile preferences at the time it is desired to be viewed (what they want when they want it) without making an active selection.

In the past, viewers of media programming were offered such programming by computing a similarity metric between programs in a “user specified selected set” (see Method And Apparatus For Generating Television Program Recommendations Based On Similarity Metric, Schaffer et al.; U.S. Pat. No. 7,454,776) requiring the viewer to first decide on the programming to be viewed. Although this method of a selected set allowed for a reflection of the viewer's preferences, it still required the viewer to be “active” in what she or he wanted to view in order to formulate the set. The set would be “offered” for selection by the viewer through “electronic programming guides” to allow the viewer to “select one or more programs that the viewer found attractive for viewing. This past methodology did not go to the next step: automatically serving up “passive” streaming media based on such preferences by “fetching” metadata without requiring the viewer to make active selections at all and, instead, allowing the viewer to sit back, relax, and just watch what the viewer intuitively wants to view at the time and place they want to view it.

There are several intrinsic challenges with prior methods used to determine and offer viewer preferences. First, these methods required active selection by the viewer. If the viewer failed to make active and accurate selections of preferred programming, prior methods could not create a selection set or, if a selection set was offered, it would not be desired by the viewer. Second, past methods for viewer preference relied on electronic programming guides (AC Nielsen, TV Guide, etc.) that were provided to the viewer in order to enable her or him to make such selections and, ultimately, allow the method to make recommendations of views. Since possible selections were primarily offered in linear fashion (“Channel 2” followed by “Channel 3” followed by “Channel 4” etc.), these programming guides were inherently flawed in not being capable of creating the optimal viewer profile. Instead, a profile was created based on first viewed or first selected programming and, therefore, resulted in inaccurate “similar shows” of media. Third, past methods for determining a viewer's preference for media were largely arbitrary by basing the selection of a “similarity metric” on supposed “weighted” factors (“station” or “title” or “actor”) that did not accurately reflect the individual viewer's preference for specific media (“title” may be given more weight by the method than that deemed necessary by the viewer, etc.). All these flaws created an imperfect means to determine viewer's distinct preference for media and then providing it in a passive means no selection necessary).

### SUMMARY OF THE SYSTEM

The system described herein works by eliminating the need for a viewer to actively select media. Instead, this new method creates a viewer passive profile by analyzing viewer and media metadata and then provides such media directly to the viewer through the system whenever the system is activated or whenever the user wants to watch it (time preference). Active selection of media by the viewer is no longer necessary. Instead, the viewer automatically receives his or her media profile preferences in a timely fashion.

### BRIEF DESCRIPTION OF THE DRAWINGS

FIG. 1 is a flow diagram of an embodiment of the system.

FIG. 2 is a flow diagram illustrating an embodiment of the system in generating a user content preference profile.

FIG. 3 is a flow diagram of an embodiment of the system for rating available content based on the user profile.

FIG. 4 is a flow diagram illustrating and embodiment of the operation of the system when the user activates the system for use.

FIG. 5 is an example of an interface in an embodiment of the system.

### DETAILED DESCRIPTION OF THE SYSTEM

LOOM The system provides a method and apparatus for selecting desired content for a user and then instantly presenting that content to the user upon activation of the system. The system tracks content selected by a user and generates a profile of the user's preferred content. The system in one embodiment uses metadata and other data associated with content selected and viewed by the user to determine a type of content preferred by the user. In addition, the user may interact with the system to provide information about content preferred by the user. This may take the form of rating or grading content during viewing, responding to requests for information periodically generated by the system, or by completing a more comprehensive user profile for use by the system.

In another embodiment, the system allows the user to use a third party profile to select content for the user. For example, the user may find that the content preferences of a third party, such as a film or television critic, a friend, a celebrity, a web site, or some other third party, coincides with the preferences of the user. The user may adopt the profile or preferences of one or more third parties to replace, complement, or supplement the preferences of the user.

The system may use the preference data of the user to come up with an interest score on all available content and ranks the content in a list of highest score to lowest score. The system in one embodiment provides the highest scoring content to the user whenever the user activates the system. In another embodiment, the system scores the content by time of day and/or day of the week, and/or by some other temporal period, and presents the highest scoring content for that temporal period when the user activates the system.

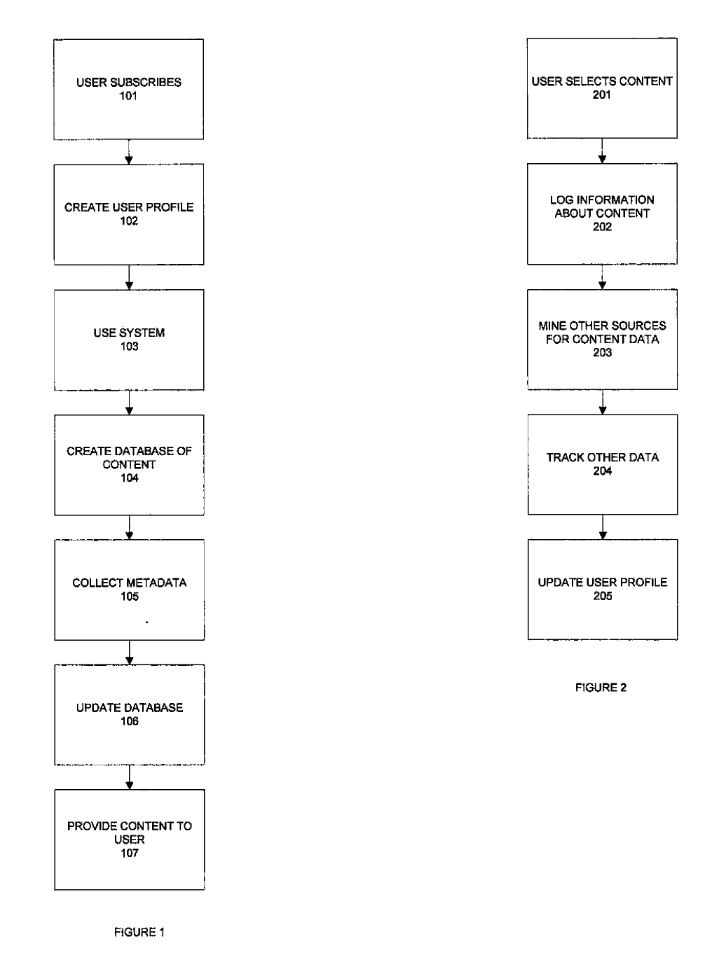

FIG. 1 is a flow diagram of an embodiment of the system. At step 101, a user subscribes to the system. At step 102 the user creates a user profile and provides some preference information. (in some embodiments, the user need not enter any profile information directly, but the system learns about the user from the user's choices and builds its own profile using subsequent steps described below). At step 103 the user begins using the system, watching television, choosing programs, recording programs, and the like. At step 104 the system creates a database of the content that is selected by the user. The system at step 105 collects metadata that is associated with the content. At step 106 the system uses the user database to update the profile of the user. At step 107 the system uses the data to identify content that will be provided instantly to the user when the user activates the system.

At step 201 the user selects content. At step 202 the system logs information about the content in the user database. This information can include any metadata associated with the content that is available with the content. Such data may include title, genre, lead actors, a summary description, etc. At step 203 the system may also seek additional information from other sources, such as via a network such as the Internet For example, the system may search the internet movie database (imdb.com) or wikipedia.org to obtain additional information including a more complete cast list, awards, additional plot description, or any information that may be used to characterize the content.

The system also tracks additional information about the content at step 204. This information includes the time of day and day of week when the content is being watched, how much of the content is watched (e.g. if it is an hour program, did the user watch the entire hour), whether it was a live presentation or a recorded presentation of content (whether from a DVD, CD, DVR, On-Demand, internet streaming, or the like), whether the user has watched the content before, whether the content is part of a series, and if the user provided any additional preference information (such as a thumbs up or thumbs down on Tivo, a star rating at an associated netflix account, etc.). At step 205 the system adds the information to the user's database to update the user's content preference profile.

FIG. 3 is a flow diagram of an embodiment of the system for rating available content based on the user profile. At step 301 the system retrieves content that is available to be viewed by the user. This can include content in a user media library, via on-line subscriptions, live broadcast schedules, and any other source of content available to the user. The system typically looks ahead at least two weeks if possible to obtain as many possible programs as possible for analysis.

At step 302 the system retrieves metadata and external data about each program as described above in FIG. 2. At step 303 the system compares each piece of content to the user profile and assigns the content a score indicating how closely the content matches up with the user content preference profile. At step 304 the system creates a ranked list of the content based on the score.

At decision block 305 the system determines if there are other profiles for which content analysis should be performed. For example, there may be a plurality of registered users on the account. In addition, each user may elect to adopt one or more third party profiles as a way of selecting content. As noted above, the system can publish, export, or import the preference profiles of third parties and make them available to users. The users themselves can share profile information as desired. For instance, there may be a celebrity, movie or television critic, blogger, friend, or other third party whose profile the user would like to adopt as his own.

If there is another profile at decision block 305, whether for another user or whether there are multiple profiles for a user, the system returns to step 303 to score the content for the next profile. If not, the system ends at step 306.

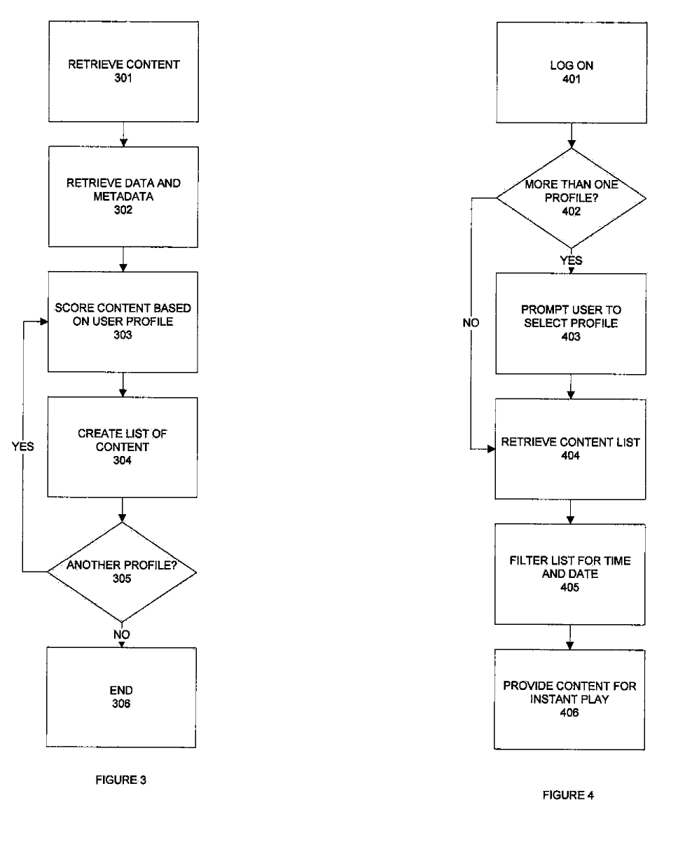

FIG. 4 is a flow diagram illustrating and embodiment of the operation of the system when the user activates the system for use. At step 401 the user activates the system. At step 402 the system determines if the user has more than one profile. If so, the system prompts the user at step 403 to select one of the profiles. If not, the system proceeds to step 404.

After the user has selected a profile at step 403, or if the user has only one profile, the system proceeds to step 404 and retrieves the appropriate content list for the user profile. At step 405 the system filters the content for the time and date. As noted above, the system includes a feature where it tracks temporal preferences of the user and ranks content accordingly. For example, the user may watch certain genres of content consistently at certain times. The user may prefer nature shows at bedtime, sitcoms in the evening, sports on weekends, news shows in the morning, etc. The system checks the time and date, and provides the preferred content to the user for that particular time.

The system provides the highest scoring show for the user to select instantly upon start up of the system at step 406. However, the system also provides an interface for the user to select any other available content if the user decides to watch something different. All content choices by the user are used to contribute to refining and updating the user profile, maximizing the chances of matching the user's desires with appropriate content.

In one embodiment, the system itself retrieves third party profiles and offers them to a user through the system interface. For example, the system may provide the ability to select from third parties such as rottentomatos.com, aintitcool.com, twitter, facebook, rankings of other system users, and the like.

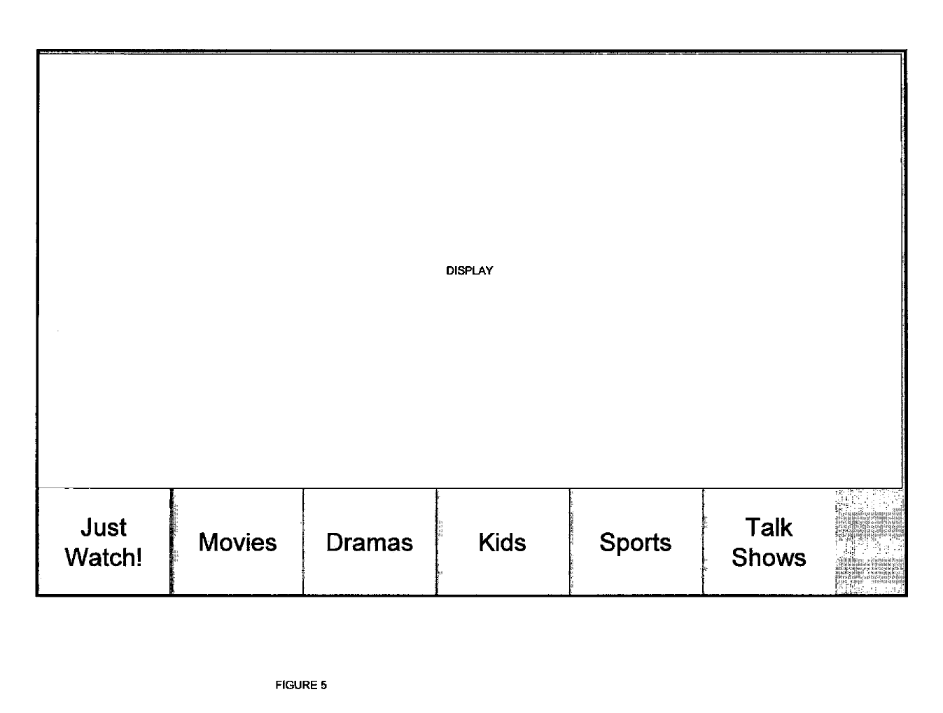

FIG. 5 is an example of a user interface in an embodiment of the system. The lower portion of the Device Screen would initially show the Main Menu of the system—located either horizontally at the bottom of the Device Screen or vertically on the Left side of the Screen, for example. The remainder of the Screen would instantly show the highest ranked show of the user.

The Main Menu overlays on top of the AV content showing in the screen, The Main Menu automatically recedes within a few seconds (can be set by viewer) after the viewer last presses any of the set remote controls except volume controls or as allowed by the set manufacturer. The Main. Menu returns if the viewer presses any of the device remote control buttons except volume or other device maker pre-set controls.

Thus, a system and method for providing desired content is described.

What is claimed is:

1. A method for presenting content comprising selecting a program based on a user profile and temporal conditions at the time of selection.
